(19) United States
(12) Patent Application Publication
(10) Pub. No.: US 2022/0009128 A1
(43) Pub. Date: Jan. 13, 2022

(54) METHOD FOR MANUFACTURING A FIBRE PREFORM

(71) Applicant: INSTITUT DE RECHERCHE TECHNOLOGIQUE JULES VERNE, Bouguenais (FR)

(72) Inventors: Xavier TARDIF, Nantes (FR); Matthieu KNEVELER, Les Sorinieres (FR)

(73) Assignee: INSTITUT DE RECHERCHE TECHNOLOGIQUE JULES VERNE, Bouguenais (FR)

(21) Appl. No.: 17/294,304

(22) PCT Filed: Nov. 12, 2019
(86) PCT No.: PCT/EP2019/080944

§ 371 Date: May 14, 2021

(30) Foreign Application Priority Data
Nov. 16, 2018 (FR) 1860639

(51) Int. Cl. B29B 11/16; C08J 5/24; B29B 11/06

(52) U.S. Cl. CPC B29B 11/16; B29B 11/06; C08J 5/244

(57) ABSTRACT

A method for manufacturing a fiber preform including a number of plies greater than or equal to two, includes: a) heating a ply; b) depositing the ply on a preforming mold; c) forming the ply, the ply then forming an intermediate preform; d) heating a new ply; e) depositing the new heated ply on the intermediate preform; f) forming the new ply in order to form a new intermediate preform; g) where applicable, repeating steps d) to f) at least once, the intermediate preform being replaced in these steps by the new intermediate preform in order to produce the fiber preform with the number of plies.

### FIELD OF THE INVENTION

The present invention relates to the field of the manufacturing of parts made of composite material, in particular, but not exclusively in the aeronautical, motor vehicle and air turbine sectors, such parts comprising a polymer matrix and a fibrous reinforcement. In particular, the invention relates to a method for manufacturing a fibrous preform, and a preform obtained by such a method. The invention relates also to a method for manufacturing a part made of composite material produced from such a preform.

### PRIOR ART AND OBJECTIVES OF THE INVENTION

To produce parts made of composite material, it is known practice to manufacture a preform and then produce a molding by resin transfer in order to obtain the part.

Such a method is known for example from U.S. Pat. No. 5,766,534. This document describes a method for preparing a composite with resin matrix, comprising the steps consisting in preparing a preform comprising a tackifier of a hardenable resin and at least two layers of a reinforcing material. This preform preparation step consists in applying the tackifier to at least one layer of reinforcing material then compressing the at least two layers of the reinforcing material and finally performing a cross-linking of the tackifier in particular conditions so as to form the preform. The method then comprises the step consisting in bringing the preform and the resin matrix into contact so as to harden the tackifier and the resin and form the composite.

Also known from WO 2012/075252 is a method for manufacturing a composite item, comprising the deposition of a preform on a mold, the heating of the mold using a network of pipes in which a fluid circulates, arranged under the surface of the mold, with particular temperature and pressure conditions, the preform being a multilayer of dry and/or pre-impregnated carbon fibers.

EP 0 981 427 describes a method for manufacturing a preform for resin transfer molding consisting in providing a multiplicity of layers of binder-coated fibers to form the layers on a molded surface, in heating the layers to a predefined temperature, in fusing the layers together and in cooling to stiffen the layers in order to form a preform.

US 2007/0020431 discloses a method for producing a component made of fibrous composite material in which several layers of reinforcing fibers are stitched together by a thread with a predefined thread tension. The preforms with reinforcing fibers are then compacted by means of the stitching, then placed in an injection mold with injection of resin.

DE 10 2011 115 730 describes a method that makes it possible to form semi-finished, fiber-reinforced thermoplastic panels to form semi-finished products of three-dimensional form.

DE 10 2011 007 018 describes a method and a device for producing fibrous preforms for the production of fiber-reinforced plastic components. A preform shaping mold is heated in order to heat the binder present on the plies and perform the forming of the plies.

The preforming time must be reduced for very thick parts, for which the plies are draped over a mold, these plies are placed in a vacuum, then the assembly is transferred into an oven and, finally, the assembly is heated to produce the preform. Given the masses to be heated, this operation takes at least 30 min. The preforming step then becomes limiting for the production of parts made of composite material, notably very thick parts.

Duplicating the molds and the ovens to speed up the rate has been considered, but that requires heavy investments and significant workshop surface areas.

There is thus a need to increase the rate of production of preforms made of fibrous reinforcement or of parts made of composite material produced from such preforms, notably very thick parts made of composite material.

### SUMMARY OF THE INVENTION

### Method for Manufacturing a Fibrous Preform

The present invention achieves all or part of this need and relates to a method for manufacturing a fibrous preform comprising a predetermined number of plies greater than or equal to two, comprising the following steps:

a) heating at least one ply,

b) depositing said at least one ply on a preforming mold,

c) performing an operation of forming of said at least one ply, said at least one ply then forming an intermediate preform,

d) heating at least one new ply,

e) depositing said at least one heated new ply on the intermediate preform,

f) performing an operation of forming of said at least one new ply so as to form a new intermediate preform,

g) possibly repeating, at least once, the steps d) to f), the intermediate preform being replaced in these steps by the new intermediate preform, so as to produce the fibrous preform with said predetermined number of plies.

The number of plies in the step a) and/or d) can be precisely one.

In a variant, the number of plies in the step a) and/or d) is precisely two.

In another variant, the number of plies in the step a) and/or d) is greater than or equal to two, this number being strictly less than the predetermined number of plies of the fibrous preform.

By virtue of the invention, the preform is produced in steps, by shaping one or more plies at a time without simultaneously shaping the predetermined total number of plies of the fibrous preform. That makes it possible to reduce the time needed to manufacture the fibrous preform, each heating step being of a short duration because of the small thickness of the ply or plies to be heated. The preforming is thus done in concurrent time.

Furthermore, the risks of defects of corrugation type that are encountered in the case of the preforming of numerous plies simultaneously, as in the prior art, are limited.

Another advantage of the invention is that the preforming mold is not heated to high temperature as is the case in the prior art. Thus, the mold is not subject to expansions or to thermal aging. That generates energy savings and a reduction of the costs through the use of less expensive materials and an extended life.

Advantageously, in the step d), the intermediate preform is also heated. The heating step d) can comprise the simultaneous heating of said at least one new ply and of the intermediate preform. The intermediate preform is preferably heated to a temperature less than that of said at least one new ply. In the heating step d), said at least one new ply is for example heated to a temperature lying between 80° C. and 200° C., for example between 100° C. and 160° C., notably to a temperature of 110° C. The intermediate preform, when heated, can be heated such that the outer surface, which will be in contact with said at least one new ply, is heated to a temperature greater than the melting temperature of a binder of said at least one new ply, notably a temperature greater than or equal to 60° C., preferably greater than 80° C., notably lying between 60° C. and 100° C. The heating temperature of the preform is advantageously less than the deconsolidation temperature of the intermediate preform. The deconsolidation for composite materials can be defined as the tendency of the composite materials to lose their consolidation upon a rising temperature, this being reflected by an increase in the void content.

Nevertheless, in the invention, the mold can be heated, for example continuously, notably to a temperature corresponding to the melting temperature of a binder of the plies, for example 60° C. In this case, the intermediate preform or new intermediate preform is permanently heated to remain at a stable temperature, for example of 60° C.

The heating steps a) and d) can be preceded by a step consisting in arranging said at least one ply and/or new ply draped flat on top of the preforming mold and/or intermediate preform, these steps being preferably performed using a needle gripper.

The heating steps a) and/or d) are, for example, performed by infrared heating. Other heating modes can be envisaged.

The heating apparatus can be arranged on and/or under said at least one (new) ply. The heating can be the same for said at least one (new) ply and the intermediate preform. As a variant, two different heating apparatuses are used.

The forming step c) and/or f) can be performed by rapid forming, notably thermoforming, of said at least one ply or a new ply by the creation of a vacuum using a deformable membrane.

The deformable membrane is not heated as is the case in the prior art. Thus, the membrane is not subjected to expansions or thermal aging. That generates energy savings and a reduction of costs through the use of less expensive materials and an extended life.

The forming step c) and/or f) is preferably followed by a step of cooling of the intermediate preform or new intermediate preform or fibrous preform. Such a cooling allows for the consolidation of the preform concerned.

The time to manufacture the fibrous preform can be rapid, notably less than 10 min, in particular less than or equal to 5 min. The heating time in the step a) and/or d) can be less than 3 min, notably equal to approximately 2 min.

Said at least one ply and/or a new ply is advantageously a dry ply.

The term “dry ply” denotes a ply of fibers impregnated with a small quantity of a binder consisting of a thermosetting or thermoplastic polymer, a quantity of between approximately 1% and 20%, notably less than approximately 5% by weight with respect to the total weight of the ply. The binder present in a small quantity can be sprinkled in powder form onto the ply or can form a web between two layers of the ply, or the like.

Each ply can have a structure chosen from the group consisting of a linear structure, notably of the threads or rovings, a surface structure, notably of nonwoven fabrics, fabrics, ribbons or matts, or a multidirectional structure, notably of braids, complex fabrics, multidirectional weaves, notably tri-directional or more.

At least one ply can be in nonwoven form, also called noncrimp fabric (NCF). In this case, the ply comprises a plurality of layers of unidirectional fibers, arranged one on top of the other with a different angular orientation of the fibers, for example according to a 0/+-45°/90° sequence. Thus, by the drape-molding of a single ply, multiple layers contained in this ply are obtained simultaneously. The layers forming a ply of nonwoven fabric can be linked to one another by stitches.

In a variant or additionally, at least one ply can be woven. In this case, the ply is advantageously a single-layer ply.

The term “woven” covers a variety of more or less complex weaving or braiding structures, that can in particular be three-dimensional. As is known per se, the weave can be a plain weave, a twill weave, a satin, a unidirectional weave, an imitation gauze or the like.

Within the fibrous preform, there can be a combination of plies made of nonwoven fabrics and woven plies.

It is also possible to have a combination of plies made of multilayer nonwoven fabrics, which are suitable for zones or parts of less complex geometry and woven or nonwoven fabric single-layer plies which may be suitable for zones or parts of more complex geometry.

The plies are preferably deformable. The term “deformable ply” denotes a ply composed of continuous fibers arranged according to defined directions and assembled in the form of fabric or nonwoven fabric.

Said at least one ply and/or said new ply comprises fibers chosen from the group consisting of glass fibers, carbon fibers, aramid fibers, ceramic fibers, polyester fibers, plant fibers, notably flax fibers, preferably glass fibers, and a mix thereof. The fibers can be continuous or short. They can differ according to the plies.

The predetermined number of plies of the fibrous preform is for example between 2 and 200, notably between 4 and 160.

The thickness of the fibrous preform with the predetermined number of plies lies, for example, between approximately 0.5 mm and 100 mm, notably between 1 mm and 80 mm, in particular between 10 mm and 80 mm, for example between 20 mm and 80 mm.

In a particular embodiment, the fibrous preform comprises 50 superposed plies and has a thickness of 25 mm, which represents a great thickness. However, the fibrous preform can have a small thickness, for example approximately 1 mm and comprise few plies, for example two plies. As a variant, in the aeronautical field, in particular, the fibrous preform can have a maximum thickness of 40 mm with 80 plies whereas, in the wind turbine field for example, the maximum thickness can be 80 mm for 160 plies.

The fibrous preform obtained by the method described above is advantageously a so-called dry preform, that is to say a fibrous preform comprising between approximately 1% and 20%, notably less than approximately 5%, of a thermosetting or thermoplastic polymer, as a percentage by weight with respect to the total weight of the preform. The dry preform is preferably used as reinforcing phase of a part made of composite material.

The plies can have dimensions that are substantially identical to one another.

Preferably, said at least one new ply is superposed on the intermediate preform, notably so as to completely cover it after the forming step.

### Fibrous Preform

Another subject of the present invention, according to another aspect, is a fibrous preform obtained using the manufacturing method as defined above, comprising said predetermined number of plies.

### Method for Manufacturing a Part Made of Composite Material

Another subject of the invention, according to another aspect, in combination with the above, is a method for manufacturing a part made of composite material comprising the following steps:
producing a fibrous preform by implementing the method as defined above,
impregnating, notably by injection or infusion, a polymer into the fibrous preform so as to obtain the part made of composite material.

The method according to the invention makes it possible to reduce the time to manufacture a part made of composite material and therefore improve the rate of production of such parts, notably when they are of large dimensions and/or very thick.

### Part Made of Composite Material

Another subject of the present invention, according to another aspect, is a part made of composite material obtained using the method for manufacturing a part made of composite material as defined above.

### BRIEF DESCRIPTION OF THE FIGURES

The invention will be able to be better understood on reading the following detailed description of nonlimiting examples of implementation thereof, and on studying the attached drawing, in which:

FIG. 1 is a block diagram illustrating the different steps of an example of a method according to the invention,

FIG. 2 is a block diagram illustrating the different steps of another example of a method according to the invention,

FIGS. 3 to 6 schematically illustrate the implementation, in cross section, of different steps of the method according to the invention,

FIG. 7 is a schematic view in cross section of an example of fibrous preform obtained with the method according to the invention, and

FIGS. 8 and 9 are graphs of temperature as a function of time applied illustrating the implementation of the method according to the invention with different parameters.

### DETAILED DESCRIPTION OF EMBODIMENTS OF THE INVENTION

Hereinafter in the description, the elements that are identical or functions that are identical bear the same reference symbol. For the brevity of the present description, they are not described in light of each of the figures, only the differences between the embodiments being described.

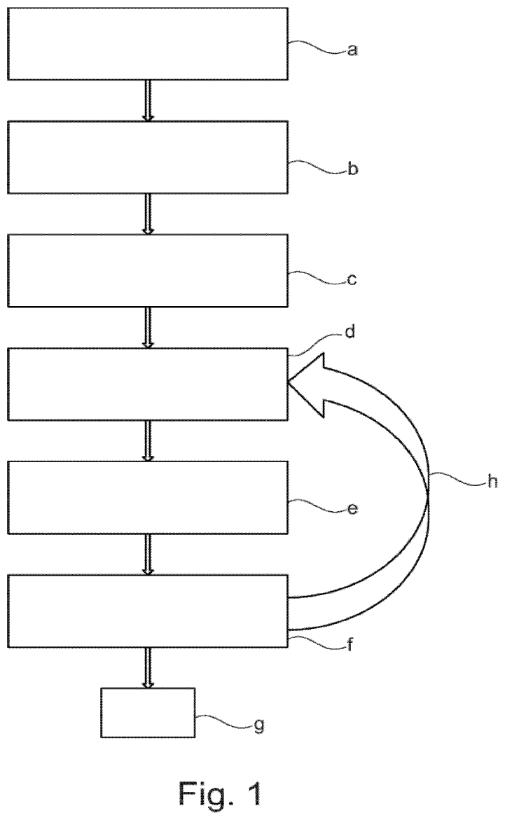

FIG. 1 shows an example of a method for manufacturing a fibrous preform comprising a predetermined number of plies greater than or equal to two, comprising the following steps.

In the step a), at least one ply is heated, in this example by infrared heating.

In the step b), said at least one ply is deposited on a preforming mold.

In the step c), an operation of forming of said at least one ply is performed, said at least one ply then forming an intermediate preform.

In the step d), at least one new ply is heated, in this example by infrared heating. In this step also, according to this embodiment, the intermediate preform is simultaneously heated, also by infrared heating. In this example, the latter is heated to a temperature, for example of 60° C., which is less than the heating temperature of the new ply, which is, for example, 110° C.

In the step e), said at least one heated new ply is deposited on the intermediate preform.

In the step f), an operation of forming of said at least one new ply is performed so as to form a new intermediate preform.

Next, if the predetermined number of plies greater than or equal to two is reached, the fibrous preform is obtained in the step g). If the predetermined number of plies greater than or equal to two is not reached, the steps d) to f) are repeated by following the arrow h), the intermediate preform being replaced in these steps by the new intermediate preform, so as to obtain, in the step g), the fibrous preform with the predetermined number of plies reached.

After the step g), the fibrous preform can be impregnated with a liquid or pasty polymer, notably by injection, in order to obtain a part made of composite material.

In this example, each ply is a dry ply produced from NCF. It advantageously comprises glass fibers.

Still in this example, the number of plies in the step a) and d) is precisely one. Thus, according to this embodiment, the preform is produced ply by ply, by heating the ply before depositing it on the intermediate preform already produced previously. That makes it possible to save on heating time since the thickness to be heated in these steps a) and d) is small.

The forming in the steps c) and f) is implemented in this example by rapid forming of said at least one ply or of said at least one new ply by the creation of a vacuum using a deformable membrane.

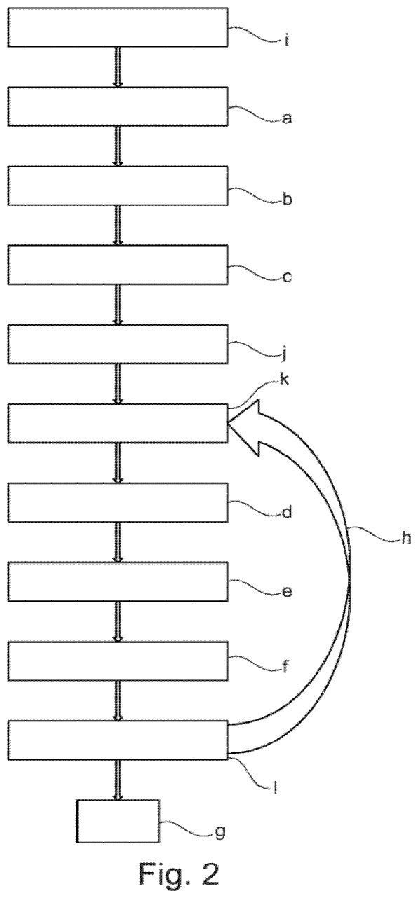

FIG. 2 shows another example of implementation of the method for manufacturing a fibrous preform according to the invention.

Once again, there are the steps a), b), c), d), e), f) and g) described above with reference to FIG. 1.

The method also comprises, in this example, a step i) prior to the step a) consisting in arranging said at least one ply draped flat on top of the preforming mold, this step being, in this example, performed using a needle gripper. Similarly, the step d) is preceded by a step k) arranging said at least one new ply draped flat on top of the intermediate preform, this step being also performed using the needle gripper in this example.

Moreover, the forming step c) is followed by a step j) of cooling of the intermediate preform. Similarly, the forming step f) is followed by a step 1) of cooling of the new intermediate preform which can then, if necessary, coincide with the fibrous preform obtained in the step g) if the predetermined number of plies is reached.

In this example, the number of plies in the steps a) and d) is precisely two plies. There is no departure from the scope of the invention if the number of plies in these steps is greater than two and strictly less than the predetermined number of plies of the fibrous preform, or is different between the steps a) and d).

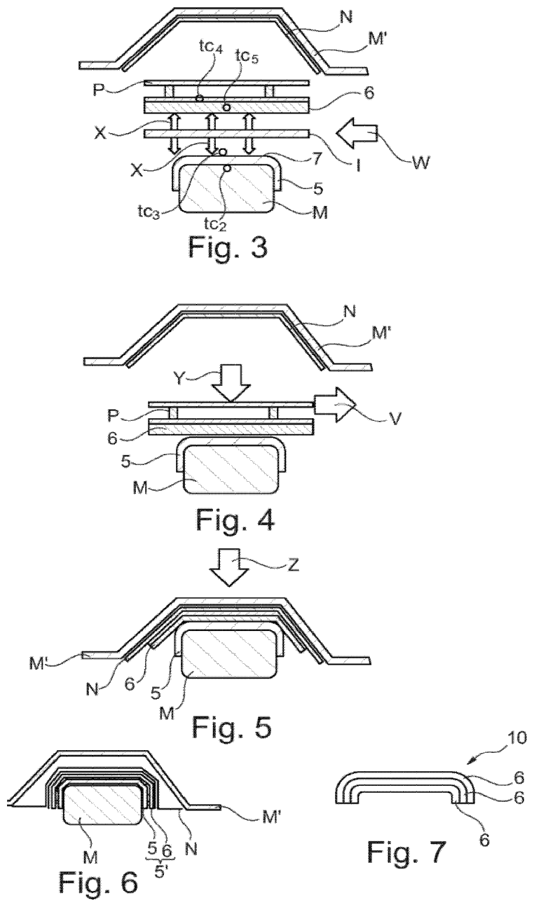

In FIG. 3, the implementation of the heating step d) of the method according to the invention is visualized. An intermediate preform 5 is arranged on a preforming mold M. Two plies 6 superposed on one another are arranged draped flat on top of the intermediate preform 5, using a needle gripper P. An infrared heating 1 is introduced in the direction of the arrow W between the intermediate preform 5 and the plies 6 so as to heat them simultaneously according to the opposing arrows X. The heating temperature can be different, being notably less for the intermediate preform 5. As a variant, it is the same for the plies 6 and for the intermediate preform 5.

FIG. 4 represents the implementation of the step e) of the manufacturing method according to the invention. The plies 6, after heating and removal from the infrared heating 1, are brought toward the previous preform 5 using the needle gripper P according to the arrow Y. Then, the needle gripper P is removed according to the arrow V after the plies 6 have been deposited on the previous preform 5.

Finally, FIGS. 5 and 6 respectively represent the start and the end of the forming step f) with a rapid forming of the plies 6 and creation of the vacuum (FIG. 6) using a deformable membrane N applied according to the arrow Z with a counter-mold M′ against the plies 6 so as to produce a new intermediate preform 5′ including the intermediate preform 5 and the plies 6. This new intermediate preform 5′, visible in FIG. 6, can be the fibrous preform 10 if the predetermined number of plies of this preform is reached.

FIGS. 3, 4, 5 and 6 respectively represent the implementation of the steps d), e) and f) but it is also possible to imagine implementation of the steps a), b) and c) if the intermediate preform 5 is removed. The ply or plies 6 are then equivalent to said at least one ply of the steps a), b) and c).

FIG. 7 schematically represents an example of fibrous preform 10 obtained using the method illustrated in FIG. 2, consisting of a superpositioning of plies 6.

A part made of composite material can be produced from this fibrous preform 10, by impregnating the latter, by injection or maceration for example, of a liquid or pasty polymer.

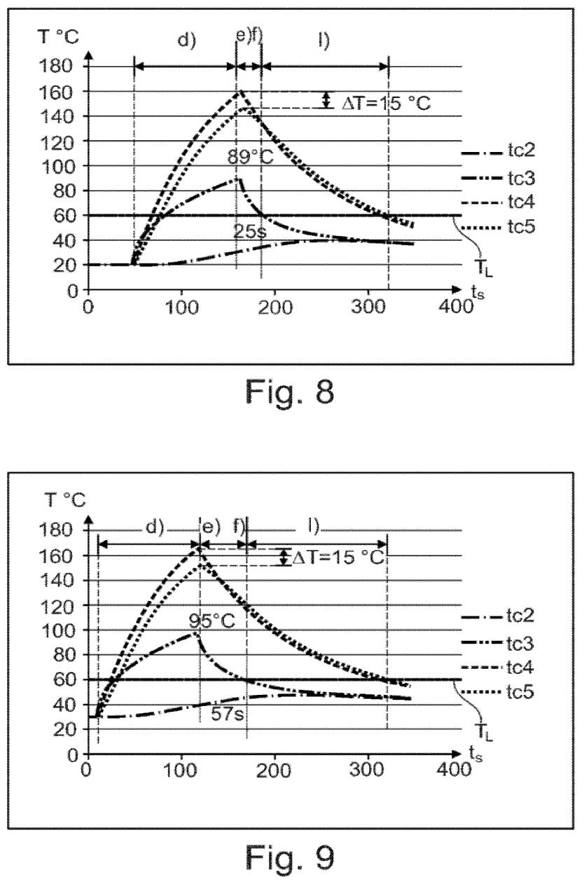

A test was performed by implementing the method according to the invention and, during this test, the variation of the temperature as a function of time was studied at precise points of the plies 6 and of the intermediate preform 5 using thermocouples tc2, tc3 arranged on the intermediate preform 5 and thermocouples tc4 and tc5 arranged on the plies 6, as can be seen in FIG. 3. The result of this study is illustrated in the graphs of FIGS. 8 and 9.

For the start of the test performed for which the graph can be seen in FIG. 8, the starting point was an intermediate preform 5 consisting of two plies 6, to which two new plies 6 were added. As can be seen in FIG. 3, the temperatures of the intermediate preform 5 are tracked by the thermocouples tc2 and tc3, tc2 being arranged on the bottom surface of the intermediate preform 5 while tc3 is arranged on the top surface of the intermediate preform 5 which will be in contact with one of the new plies 6. The temperatures of the plies 6 are tracked by the thermocouples tc4 and tc5, tc4 being arranged on the top ply and tc5 is arranged on the bottom ply which will be in contact with the intermediate preform 5. The rest of the test performed for which the graph can be seen in FIG. 9 corresponds to the rest of the implementation of the method, with the addition, on the new intermediate preform 5′, of two new plies 6. The thermocouples tc2, tc3, tc4 and tc5 are then respectively arranged on the new intermediate preform 5′ and on the new plies 6.

The melting temperature T_{L} of the binder is, in this test, 60° C.

For the start of the test for which the result T(t) is illustrated in FIG. 8, the step d) is implemented by applying, for 120 s, the infrared heating with an infrared oven power of 50%. The temperature of the intermediate preform and of the plies increases. At the end of this heating, it is found that the temperature difference AT between the two plies 6 is 15° C. and that the temperature of the top surface of the intermediate preform 5 has reached 89° C.

Then, heating is stopped and the step e) of deposition of the new plies 6 is implemented, followed by the step f) of forming of these plies before the temperature of the top surface of the intermediate preform reaches the melting temperature T_{L} of the binder, which is 60° C. in this example. It can thus be seen, in the graph of FIG. 8, that 25 s are available to perform these two steps, the top surface of the intermediate preform 5 taking this time to go from 89° C. to 60° C. Indeed, the different plies can be bonded together only above this temperature. Then comes the cooling step 1) which, in this example, takes 200 s, the different temperatures of the plies/preform continuing to lower, as can be seen, until the new plies reach the temperature of 60° C.

Then, the rest of the test is performed with the rest of the method with the new intermediate preform 5′, by adding two new plies 6. In a new step d), heating is applied for 120 s with an infrared oven power of 50%. The temperature of the new intermediate preform and of the new plies increases, as can be seen in FIG. 9. At the end of this heating, it is found that the temperature difference AT between the two new plies 6 is 15° C. and that the temperature of the top surface of the intermediate preform 5 has reached 95° C. It should be noted that the starting temperature was not 20° C. as at the outset, but 30° C., the cooling of the new intermediate preform not being complete.

Then, the heating is stopped and the step e) of deposition of the new plies 6 is implemented, followed by the step f) of forming of these plies before the temperature of the top surface of the intermediate preform reaches the melting temperature T_{L} of the binder, which is still 60° C. in this example. It can also be seen, in the graph of FIG. 9, that 57 s are available for performing these two steps, the top surface of the intermediate preform 5 taking this time to go from 95° C. to 60° C. Then comes the cooling step 1) of 200 s, the temperatures continuing to lower until the new plies reach the temperature of 60° C.

It is found, in viewing these graphs, that it takes a relatively short time to heat the intermediate preform and the plies to be deposited. The method according to the invention thus makes it possible to preform two plies on an intermediate preform in 345 s compared to 30 min for four plies in the prior art, which is advantageous.

It is also found that it is more advantageous to have a temperature of the top surface of the intermediate preform or new intermediate preform which is higher at the end of the heating, as in the rest of the test, in FIG. 9, because that makes it possible to have more time to perform the steps e) and f). In this example, the starting temperature is higher, which explains why the temperature of the top surface reaches a higher value at the end of the heating. It is also possible to envisage increasing the heating power and/or the heating time to increase this time.

The mold M can also be heated in such a way as to maintain the temperature of the intermediate preform at a temperature at least equal to the melting temperature of the binder.

1. A method for manufacturing a fibrous preform comprising a predetermined number of plies greater than or equal to two, comprising the following steps:
a) heating at least one ply,
b) depositing said at least one ply on a preforming mold,
c) performing an operation of forming of said at least one ply, said at least one ply then forming an intermediate preform,
d) heating at least one new ply,
e) depositing said at least one heated new ply on the intermediate preform,
f) performing an operation of forming of said at least one new ply so as to form a new intermediate preform,
g) possibly repeating, at least once, the steps d) to f), the intermediate preform being replaced in these steps by the new intermediate preform, so as to produce the fibrous preform with said predetermined number of plies.

2. The method as claimed in claim 1, wherein the number of plies in the step a) and/or d) is precisely one.

3. The method as claimed in claim 1, wherein the number of plies in the step a) and/or d) is precisely two.

4. The method as claimed in claim 1, wherein the number of plies in the step a) and/or d) is greater than or equal to two, this number being strictly less than the predetermined number of plies of the fibrous preform.

5. The method as claimed in claim 1, wherein, in the step d), the intermediate preform is also heated.

6. The method as claimed in claim 1, wherein the heating step d) comprises the simultaneous heating of said at least one new ply and of the intermediate preform.

7. The method as claimed in claim 1, wherein, in the heating step d), said at least one new ply is heated to a temperature lying between 80° C. and 200° C., and the intermediate preform is heated such that the outer surface of the intermediate preform, which will be in contact with said at least one new ply, is heated to a temperature greater than the melting temperature of a binder of said at least one new ply, notably greater than or equal to 60° C., and less than the deconsolidation temperature of the intermediate preform.

8. The method as claimed in claim 1, wherein the heating steps a) and/or d) are preceded by a step consisting in arranging said at least one ply and/or new ply draped flat on top of the preforming mold and/or intermediate preform, these steps being preferably performed using a needle gripper.

9. The method as claimed in claim 1, wherein the heating steps a) and/or d) are performed by infrared heating.

10. The method as claimed in claim 1, wherein the forming step c) and/or f) is performed by rapid forming of said at least one ply or a new ply by creation of a vacuum using a deformable membrane.

11. The method as claimed in claim 1, wherein the forming step c) and/or f) is followed by a step of cooling of the intermediate preform or new intermediate preform or fibrous preform.

12. The method as claimed in claim 1, wherein the thickness of the fibrous preform with the predetermined number of plies lies between approximately 0.5 mm and 100 mm.

13. The method as claimed in claim 1, wherein said at least one ply and/or a new ply is a dry ply.

14. The method as claimed in claim 1, wherein said at least one ply and/or said new ply comprises fibers chosen from the group consisting of glass fibers, carbon fibers, aramid fibers, ceramic fibers, polyester fibers, plant fibers, notably flax fibers, preferably glass fibers, and a mix thereof.

15. The method as claimed in claim 1, wherein the predetermined number of plies of the fibrous preform is between 2 and 200.

16. A method for manufacturing a part made of composite material comprising the following steps:
producing a fibrous preform by implementing the method as claimed in claim 1,
impregnating a polymer into the fibrous preform so as to obtain the part made of composite material.
